(19) United States
(12) Patent Application Publication
(10) Pub. No.: US 2026/0152126 A1
(43) Pub. Date: Jun. 4, 2026

(54) HANDRAIL ASSEMBLY FOR WORK MACHINE

(71) Applicant: Caterpillar Inc., Peoria, IL (US)

(72) Inventors: Nirmal Goldwin, Bangalore (IN); Raghavendra Neela, Hyderabad (IN); Robert A. Harding, Wynyard (AU); Sriharsha Hebbani Nagaraja, Burnie (AU)

(73) Assignee: Caterpillar Inc., Peoria, IL (US)

(21) Appl. No.: 18/966,321

(22) Filed: Dec. 3, 2024

(51) Int. Cl. B60R 3/00

(52) U.S. Cl. CPC B60R 3/005

(57) ABSTRACT

A handrail assembly for a work machine includes a handrail. The handrail includes an upper handrail portion and a lower handrail portion. The upper handrail portion includes a pair of first members and the lower handrail portion includes a pair of second members. Each second member defines an opening. The handrail is movable between a deployed position and a folded position. The upper handrail portion is pivotable relative to the lower handrail portion to move the handrail between the deployed position and the folded position. The handrail assembly also includes a pair of locking mechanisms that removably couple the upper handrail portion with the lower handrail portion. To dispose the handrail in the deployed position, each locking mechanism engages the first member with a corresponding second member. To dispose the handrail in the folded position, each locking mechanism disengages the first member from the corresponding second member.

### TECHNICAL FIELD

The present disclosure relates to a work machine, and more particularly, to a handrail assembly for the work machine and a method of operating the handrail assembly of the work machine.

### BACKGROUND

A work machine, such as a wheel loader, is often used to perform a number of applications at worksites. The work machine includes a handrail assembly that may assist an operator, for example, to access one or more components of the work machine or to overlook machine operations. The handrail assembly includes a handrail that is movable between a deployed position and a folded position. When the handrail is not in use, the handrail may be moved to the folded position. The handrail includes a lower handrail portion and an upper handrail portion that is pivotable relative to the lower handrail portion. Specifically, in the deployed position, the upper handrail portion engages with the lower handrail portion such that the handrail may be held by the operator. Further, when the handrail is in the folded position, the upper handrail portion does not engage with the lower handrail portion.

A hinge joint is present in conventional handrails to move the handrail between the deployed and folded position. Such a hinge joint may present a pinch point, due to which operators may have to be careful while moving the handrail. Currently, in the deployed position of the handrail, the upper handrail portion is locked with the lower handrail portion via one or more lynch pins. However, the lynch pins may get damaged due to load forces that are subjected by a weight of the upper handrail portion. Further, due to repetitive movement of the handrail between the deployed position and the folded position, the lynch pins may break due to impact loads. Moreover, after a period of time, the lynch pins may start to corrode and may break while the handrail is being used, which is not desirable. In some examples, the lynch pins are held by chains which may get caught with components on a deck of the work machine, which may damage components of the work machine or the chains itself.

U.S. Pat. No. 5,676,460 describes a concrete mixing truck having an apparatus for mixing materials used to make concrete includes a mixing product receiving and delivery assembly, a platform, which is located proximate the mixing product receiving and delivery assembly for providing operator access thereto, and a repositionable safety rail. The safety rail is located on and partially encloses the platform and is positionable, via a hinge or other suitable means, between an upraised position and a lowered position. With the safety rail in the upraised position, an operator present on the platform is provided with an added measure of safety to prevent against accidental falling and resulting injury. With the safety rail in a lowered position, the platform is essentially inaccessible to operators and the mixing product receiving and delivery assembly is unobscured and completely accessible to machinery such as associated with a ready-mix concrete plant.

### SUMMARY OF THE DISCLOSURE

In an aspect of the present disclosure, a handrail assembly for a work machine is provided. The handrail assembly includes a handrail adapted to be coupled to a frame of the work machine. The handrail includes an upper handrail portion and a lower handrail portion. The upper handrail portion includes a pair of first members spaced apart from each other. The lower handrail portion includes a pair of second members spaced apart from each other. Each second member from the pair of second members defines an opening. The handrail is movable between a deployed position and a folded position. The upper handrail portion is pivotable relative to the lower handrail portion to move the handrail between the deployed position and the folded position. The handrail assembly also includes a pair of locking mechanisms that removably couple the upper handrail portion with the lower handrail portion. To dispose the handrail in the deployed position, each locking mechanism from the pair of locking mechanisms engages the first member of the upper handrail portion with a corresponding second member of the lower handrail portion. To dispose the handrail in the folded position, each locking mechanism from the pair of locking mechanisms disengages the first member of the upper handrail portion from the corresponding second member of the lower handrail portion.

In another aspect of the present disclosure, a work machine is provided. The work machine includes a frame. The work machine also includes a handrail assembly removably coupled with the frame. The handrail assembly includes a handrail including an upper handrail portion and a lower handrail portion. The upper handrail portion includes a pair of first members spaced apart from each other. The lower handrail portion includes a pair of second members spaced apart from each other. Each second member from the pair of second members defines an opening. The handrail is movable between a deployed position and a folded position. The upper handrail portion is pivotable relative to the lower handrail portion to move the handrail between the deployed position and the folded position. The handrail assembly also includes a pair of locking mechanisms that removably couple the upper handrail portion with the lower handrail portion. To dispose the handrail in the deployed position, each locking mechanism from the pair of locking mechanisms engages the first member of the upper handrail portion with a corresponding second member of the lower handrail portion. To dispose the handrail in the folded position, each locking mechanism from the pair of locking mechanisms disengages the first member of the upper handrail portion from the corresponding second member of the lower handrail portion.

In yet another aspect of the present disclosure, a method of operating a handrail assembly of a work machine is provided. The method includes providing a handrail of the handrail assembly. The handrail includes an upper handrail portion and a lower handrail portion. The upper handrail portion includes a pair of first members spaced apart from each other. The lower handrail portion includes a pair of second members spaced apart from each other. Each second member from the pair of second members defines an opening. The handrail is movable between a deployed position and a folded position. The method also includes pivoting the upper handrail portion relative to the lower handrail portion to dispose the handrail in the deployed position. The method further includes engaging, via a pair of locking mechanisms of the handrail assembly, the first member of the upper handrail portion with a corresponding second member of the lower handrail portion. Each locking mechanism from the pair of locking mechanisms is removably coupled to a corresponding upper handrail portion and a corresponding lower handrail portion. The method further includes disposing the handrail in the deployed position based on the engagement of the first member of the upper handrail portion with the corresponding second member of the lower handrail portion. The method includes disengaging, via the pair of locking mechanisms, the first member of the upper handrail portion from the corresponding second member of the lower handrail portion. The method also includes pivoting the upper handrail portion relative to the lower handrail portion based on the disengagement of the first member of the upper handrail portion from the corresponding second member of the lower handrail portion. The method further includes disposing the handrail in the folded position based on the pivoting of the upper handrail portion relative to the lower handrail portion.

Other features and aspects of this disclosure will be apparent from the following description and the accompanying drawings.

### BRIEF DESCRIPTION OF THE DRAWINGS

FIG. 1 is a schematic perspective view of a work machine, according to an example of the present disclosure;

FIG. 2 is a schematic perspective view illustrating a handrail assembly coupled to a portion of the work machine of FIG. 1, according to an example of the present disclosure;

FIG. 3A is a schematic perspective view of a handrail of the handrail assembly of FIG. 2 in a deployed position;

FIG. 3B is a schematic perspective view of the handrail of FIG. 2 in a folded position;

FIGS. 4A to 5B are schematic perspective views illustrating various components of a locking mechanism associated with the handrail assembly of FIGS. 3A and 3B;

FIG. 6 is a schematic perspective view of a lower handrail portion of the handrail of FIGS. 3A and 3B;

FIGS. 7A and 7B are schematic perspective views of the locking mechanism of the handrail assembly of FIGS. 3A and 3B in a disengaged position and an engaged position, respectively; and

FIG. 8 is a flowchart for a method of operating the handrail assembly of FIGS. 3A to 7B of the work machine, according to an example of the present disclosure.

### DETAILED DESCRIPTION

Wherever possible, the same reference numbers will be used throughout the drawings to refer to the same or like parts.

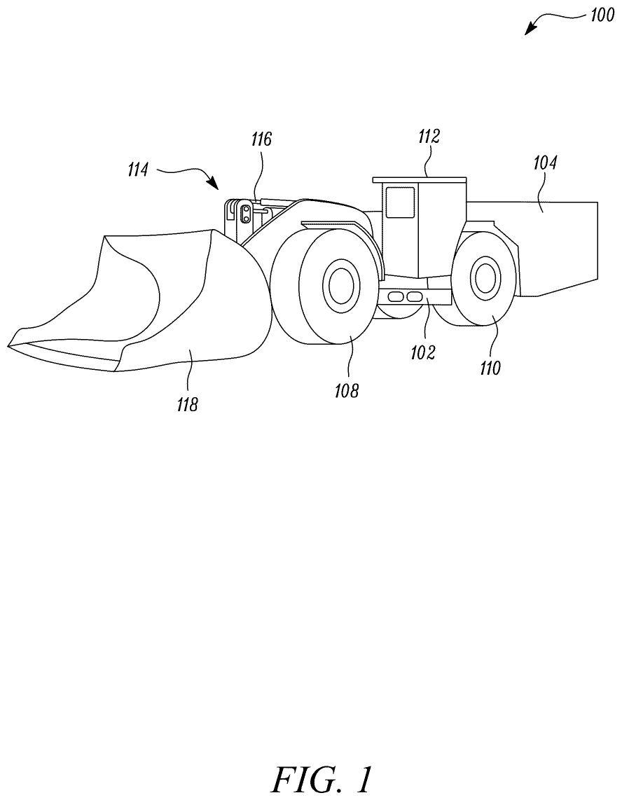

Referring to FIG. 1, a schematic perspective view of a work machine 100 is illustrated. The work machine 100 is embodied as an underground loader. Alternatively, the work machine 100 may include any other machine, such as an articulated truck, that includes a handrail assembly. Alternatively, the work machine 100 may include a dozer, an excavator, a track-type tractor, a motor grader, a milling machine, and the like that may be used to perform work operations at different worksites.

The work machine 100 includes a frame 102 that supports various components of the work machine 100. The work machine 100 also includes a hood 104 mounted on the frame 102. Further, the work machine 100 includes a prime mover (not shown) supported by the frame 102. The prime mover is disposed within the hood 104. The prime mover may provide power to various components of the work machine 100 for operational and mobility requirements. The prime mover may include a battery system, a fuel cell, and/or an engine for example, an internal combustion engine.

The work machine 100 includes a pair of front wheels 108 and a pair of rear wheels 110. The front wheels 108 and the rear wheels 110 provide support and mobility to the work machine 100 on grounds. In other examples, the work machine 100 may include two or more pairs of front wheels 108 and/or the rear wheels 110. Alternatively, the work machine 100 may include tracks instead of the wheels 108, 110.

Further, the work machine 100 includes an operator cabin 112 supported by the frame 102. The work machine 100 also includes a linkage assembly 114 coupled with the frame 102. The linkage assembly 114 is movably coupled with the frame 102. The linkage assembly 114 includes a pair of linkage arms 116 (only one of which is shown in the view shown in FIG. 1) coupled with the frame 102 at one end thereof.

The work machine 100 also includes a work implement 118. The linkage assembly 114 movably couples the work implement 118 with the frame 102. The work implement 118 is embodied as a bucket herein. Alternatively, the work implement 118 may include a blade or any other work implement. The work implement 118 may engage with material while the work machine 100 is in operation.

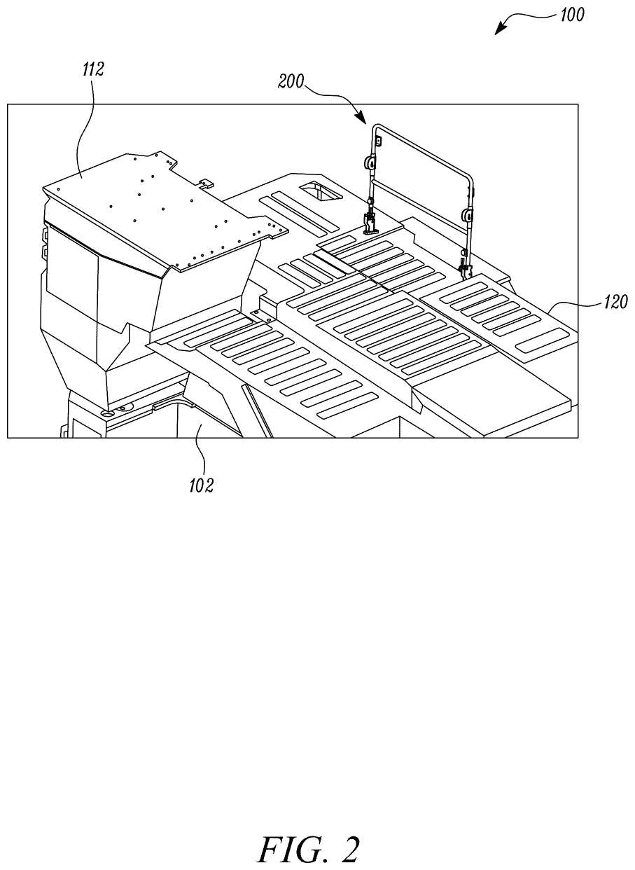

Referring to FIG. 2, a schematic perspective view of a portion of the work machine 100 of FIG. 1 is illustrated. The work machine 100 includes a handrail assembly 200 removably coupled with the frame 102. Specifically, the handrail assembly 200 is coupled to a walkway 120 of the work machine 100. It should be noted that the handrail assembly 200 may be positioned at any location on the work machine 100 as per requirements. In some examples, the work machine 100 may include any number of handrail assembly 200 based on application attributes.

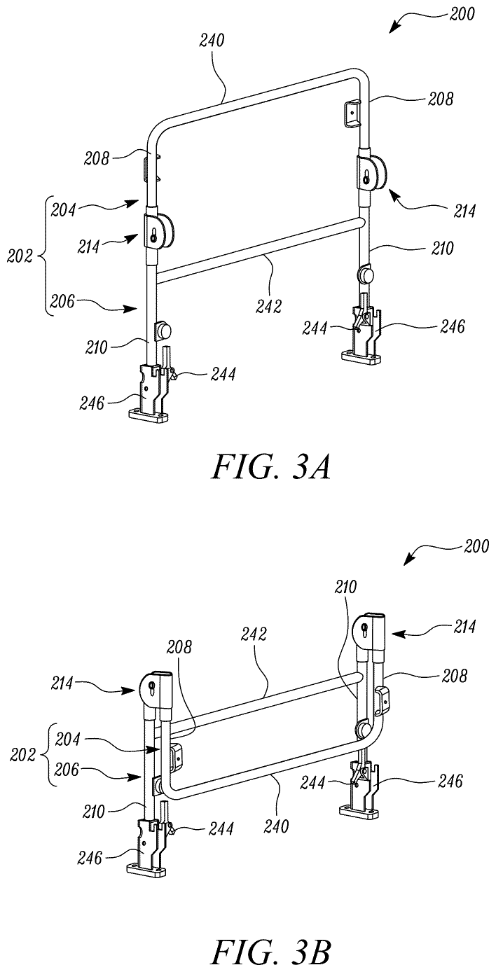

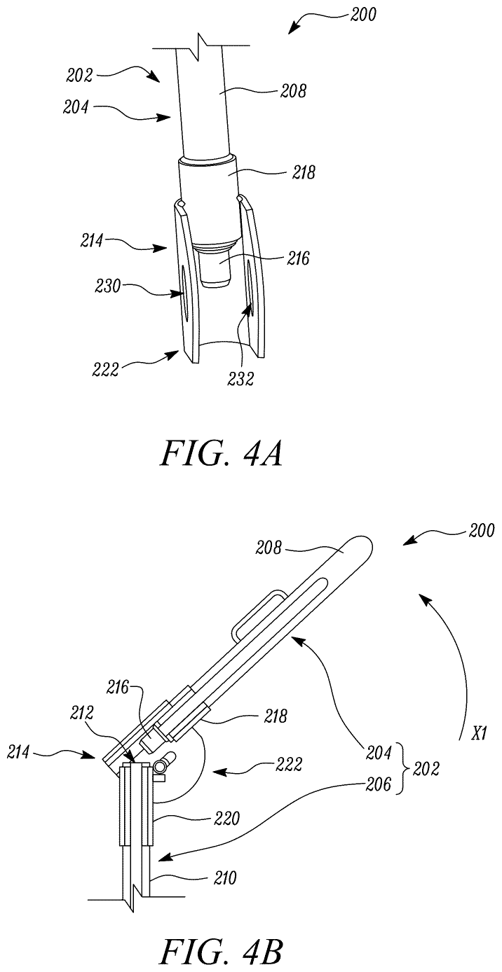

Referring to FIGS. 3A and 3B, a schematic perspective view of the handrail assembly 200 for the work machine 100 is illustrated. The handrail assembly 200 includes a handrail 202 coupled to the frame 102 (see FIG. 1) of the work machine 100. The handrail 202 includes an upper handrail portion 204 and a lower handrail portion 206. The handrail assembly 200 further includes a pair of coupling brackets 246 and a number of fastening elements 244. Specifically, the lower handrail portion 206 is coupled to the frame 102 of the work machine 100 via the coupling brackets 246 and the fastening elements 244. The lower handrail portion 206 is pivotably coupled with the coupling brackets 246. Further, the lower handrail portion 206 may be moved to a folded state (not shown herein) based on a pivoting of the lower handrail portion 204 relative to the coupling brackets 246.

The upper handrail portion 204 includes a pair of first members 208 spaced apart from each other. The upper handrail portion 204 also includes a first portion 240. The first portion 240 is integrally coupled with each of the pair of first members 208 at either ends thereof. Further, the lower handrail portion 206 includes a pair of second members 210 spaced apart from each other. The lower handrail portion 206 also includes a second portion 242. The second portion 242 is integrally coupled with each of the pair of second members 210 at either ends thereof.

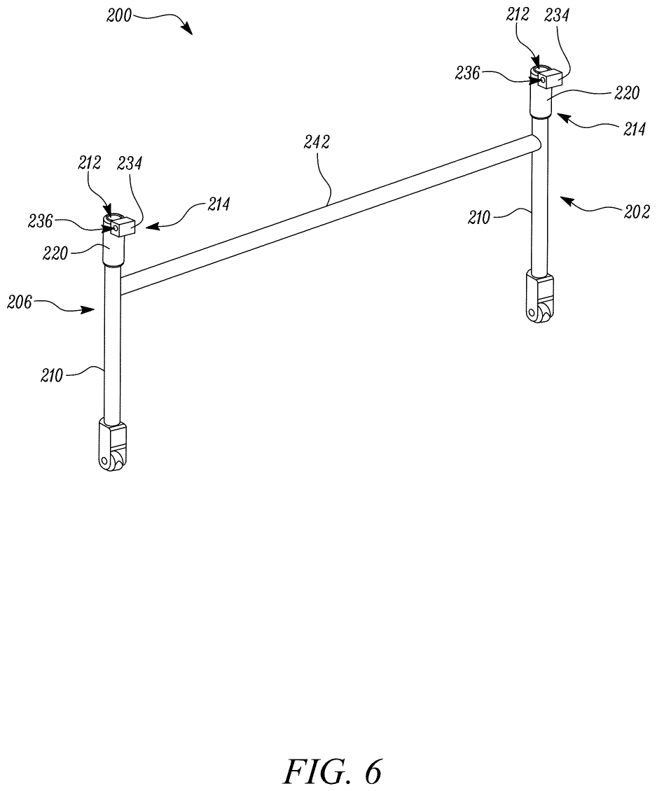

Each second member 210 from the pair of second members 210 defines an opening 212 (shown in FIG. 6). The handrail 202 is movable between a deployed position and a folded position. Specifically, the handrail 202 is illustrated in the deployed position in FIG. 3A. Further, the handrail 202 is illustrated in the folded position in FIG. 3B.

The upper handrail portion 204 is pivotable relative to the lower handrail portion 206 to move the handrail 202 between the deployed position and the folded position. In some examples, each of the upper handrail portion 204 and the lower handrail portion 206 may be made of mild steel. In some other examples, each of the upper handrail portion 204 and the lower handrail portion 206 may be made of any other metallic material, a composite, an alloy, a polymeric material, or combination thereof, without limiting the scope of the present disclosure

The handrail assembly 200 also includes a pair of locking mechanisms 214 that removably couple the upper handrail portion 204 with the lower handrail portion 206. To dispose the handrail 202 in the deployed position, each locking mechanism 214 from the pair of locking mechanisms 214 engages the first member 208 of the upper handrail portion 204 with a corresponding second member 210 of the lower handrail portion 206. Further, to dispose the handrail 202 in the folded position, each locking mechanism 214 from the pair of locking mechanisms 214 disengages the first member 208 of the upper handrail portion 204 from the corresponding second member 210 of the lower handrail portion 206. In some examples, various components of the locking mechanisms 214 may be made of mild steel. In other examples, various components of the locking mechanisms 214 may be made of any other metallic material, a composite, an alloy, a polymeric material, or combination thereof, without limiting the scope of the present disclosure.

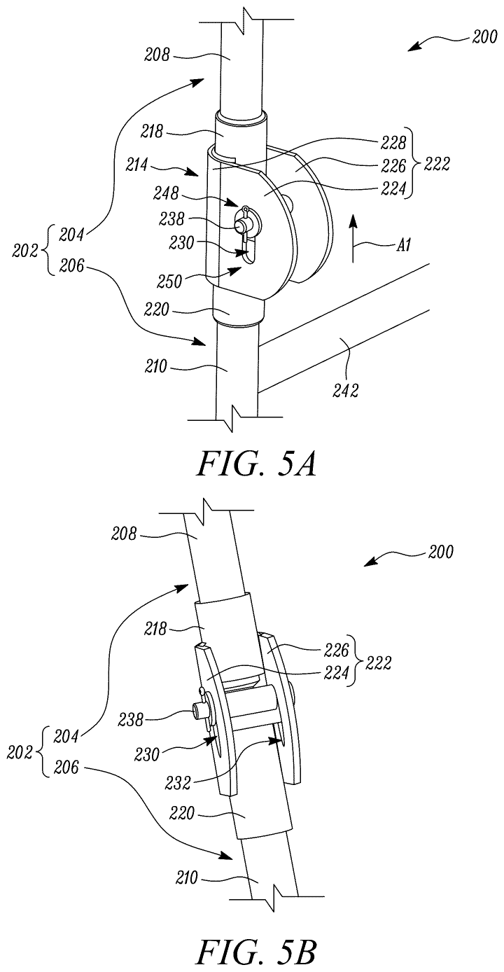

With reference to FIGS. 4A and 4B, each locking mechanism 214 from the pair of locking mechanisms 214 includes an insert 216 fixedly coupled with a corresponding first member 208. In some examples, the insert 216 may be coupled to the first member 208 by welding, soldering, brazing, or any other joining technique known to a person skilled in the art. When the handrail 202 is in the deployed position, the insert 216 is received within the opening 212 of the corresponding second member 210 of the lower handrail portion 206 to engage the first member 208 of the upper handrail portion 204 with the second member 210 of the lower handrail portion 206.

Further, to move the handrail 202 from the deployed position to the folded position, the upper handrail portion 204 is lifted to disengage the insert 216 from the opening 212 of the corresponding second member 210 of the lower handrail portion 206.

Further, each locking mechanism 214 from the pair of locking mechanisms 214 includes a first tube 218 fixedly coupled with the corresponding first member 208 of the upper handrail portion 204. The first tube 218 is embodied as a double tube herein. In some examples, the first tube 218 may be coupled to the first member 208 by welding, soldering, brazing, or any other joining technique known to a person skilled in the art. Further, each locking mechanism 214 from the pair of locking mechanisms 214 includes a second tube 220 fixedly coupled with the corresponding second member 210 of the lower handrail portion 206. The second tube 220 is embodied as a double tube herein. In some examples, the second tube 220 may be coupled to the first member 208 by welding, soldering, brazing, or any other joining technique known to a person skilled in the art.

Referring to FIGS. 5A and 5B, each locking mechanism 214 from the pair of locking mechanisms 214 includes a pair of first brackets 222. Each first bracket 222 is fixedly coupled with a corresponding first tube 218. In some examples, each first bracket 222 may be fixedly coupled with the corresponding first tube 218 by welding. In other examples, each first bracket 222 may be fixedly coupled with the corresponding first tube 218 by any other joining techniques known in the art.

Each first bracket 222 from the pair of first brackets 222 includes a first plate 224, a second plate 226, and an intermediate plate 228 that connects the first plate 224 and the second plate 226. The first brackets 222 are substantially C-shaped. The first plate 224 defines a first slot 230. The second plate 226 defines a second slot 232. The first slot 230 is in alignment with the second slot 232. Each of the first and second slots 230, 232 is oval in shape.

Referring to FIG. 6, a schematic perspective view of a portion of the handrail assembly 200 is illustrated. Each locking mechanism 214 from the pair of locking mechanisms 214 includes a second bracket 234 fixedly coupled with a corresponding second tube 220. The second bracket 234 is embodied as a rectangular box herein. However, the second bracket 234 may have any other shape. In some examples, the second bracket 234 may be fixedly coupled with the corresponding second tube 220 by welding. In other examples, the second bracket 234 may be fixedly coupled with the corresponding second tube 220 by any other joining techniques known in the art.

Each second bracket 234 defines a through-opening 236. When the handrail 202 is in the deployed position, the through-opening 236 in a corresponding second bracket 234 aligns with each of the first and second slots 230, 232 (see FIGS. 5A and 5B) in a corresponding first bracket 222 (see FIG. 5A).

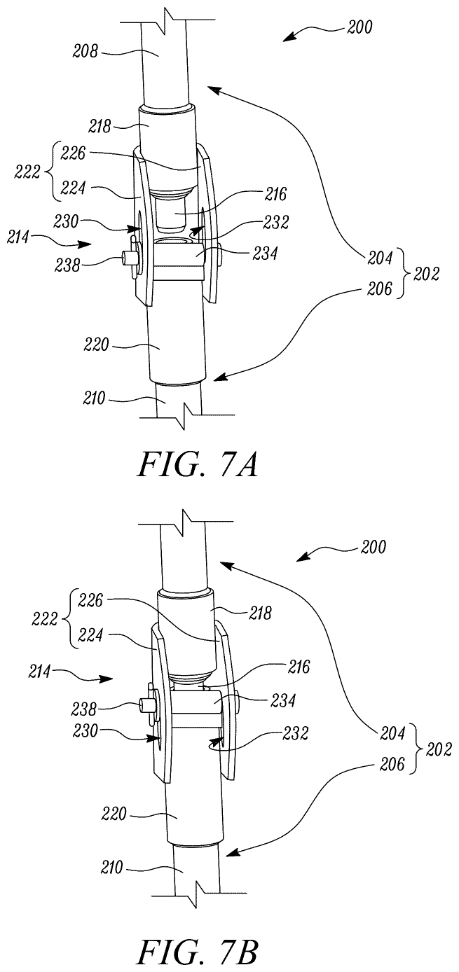

With reference to FIGS. 7A and 7B, each locking mechanism 214 from the pair of locking mechanisms 214 includes a fastener 238. The fastener 238 movably couples the first bracket 222 with the second bracket 234. The fastener 238 is received within each of a corresponding first slot 230 in the first plate 224, a corresponding second slot 232 in the second plate 226, and a corresponding through-opening 236 (see FIG. 6) in the second bracket 234. The fastener 238 is slidable within the corresponding first slot 230 and the corresponding second slot 232 during a movement of the handrail 202 between the deployed position and the folded position. In some examples, the fastener 238 may include a pin, a bolt, a screw, and the like, without limiting the scope of the present disclosure.

With reference to FIGS. 4B, 5A, and 5B, in an example, to move the handrail 202 from the folded position to the deployed position, the upper handrail portion 204 may be rotated in a direction X1 such that the insert 216 is received within the opening 212 of the corresponding second member 210 of the lower handrail portion 206 due to a weight of the upper handrail portion 204 and/or gravity. During a movement of the handrail 202 from the folded position to the deployed position, the fastener 238 slides within the corresponding first slot 230 and the corresponding second slot 232 in a direction A1 to allow receipt of the insert 216 within the second member 210. It should be noted that, when the insert 216 is received within the second member 210, the fastener 238 is disposed proximal to a top end 248 of each of the first and second slots 230, 232.

With reference to FIGS. 4B, 5A, 5B, and 7A, in an example, to move the handrail 202 from the deployed position to the folded position, the upper handrail portion 204 is lifted to disengage the insert 216 from the opening 212 of the corresponding second member 210 of the lower handrail portion 206. During a movement of the handrail 202 from the deployed position to the folded position, the fastener 238 slides within the corresponding first slot 230 and the corresponding second slot 232 in a direction opposite to the direction A1. Further, the upper handrail portion 204 is rotated in a direction opposite to the direction X1 to dispose the handrail 202 in the folded position. It should be noted that, when the handrail 202 is moved from the deployed position to the folded position, the fastener 238 is disposed proximal to a bottom end 250 of each of the first and second slots 230, 232.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the handrail assembly 200 for the work machine 100. The handrail assembly 200 described herein may be used in various work machines and at different worksites. The handrail assembly 200 may be particularly advantageous for work machines that operate at underground worksites, as such underground worksites have restrictions in terms of height and weight, and it may be required to move components, such as the handrail 202, to the folded position when not in use.

The handrail assembly 200 in accordance with the present disclosure may be simple in design as the handrail assembly 200 does not include complex components, may present a three-point contact for operators, and is free of any pinch points, sharp corners, and protrusions. Further, the handrail assembly 200 may be easy to handle and move between the deployed position and the folded position, therefore, the handrail assembly 200 of the present disclosure may require lesser manual efforts as compared to conventional handrail assemblies.

The locking mechanism 214 described herein is a positive locking system that does not interfere with nearby components of the work machine 100. Further, the locking mechanism 214 does not include any springs or lynch pins and, hence, can be used in work machines operating at underground worksites.

To move the handrail 202 from the folded position to the deployed position, the upper handrail portion 204 may be rotated in the direction X1 by an operator. Once the insert 216 aligns and engages with the opening 212 in the second member 210, the upper handrail portion 204 is coupled with the lower handrail position 206 and retained therein by gravity. Further, the upper handrail portion 204 does not disengage with the lower handrail portion 206 without manual lifting by the operator.

To move the handrail 202 from the deployed position to the folded position, the operator may lift the upper handrail portion 204 to disengage the insert 216 from the opening 212 of the corresponding second member 210 of the lower handrail portion 206. Further, the operator may rotate the upper handrail portion 204 in the direction opposite to the direction X1 to dispose the handrail 202 in the folded position.

Further, each locking mechanism 214 of the handrail assembly 200 includes the first tube 218 and the second tube 220. Each of the first tube 218 and the second tube 220 may improve a strength and a durability of the handrail 202. Further, each of the first tube 218 and the second tube 220 may prevent the handrail 202 from damage due to large load forces that may be subjected by the weight of the upper handrail portion 204. Furthermore, each of the first tube 218 and the second tube 220 may prevent the locking mechanisms 214 from damage due to impact loads caused due to repetitive movement of the handrail 202 between the deployed position and the folded position.

The handrail assembly 200 is made of strong and durable components and may be reliable in operation. The handrail assembly 200 may be easy and cost-effective to repair and may also have a long service life. Further, the handrail assembly 200 described herein may reduce manual efforts as the handrail assembly 200 may not require external tools to move the handrail 202 between the deployed position and the folded position. Overall, the handrail assembly 200 may include fewer part numbers when compared to conventional handrail assemblies, may be cost-effective, may be time efficient, and may be retrofitted on existing work machines.

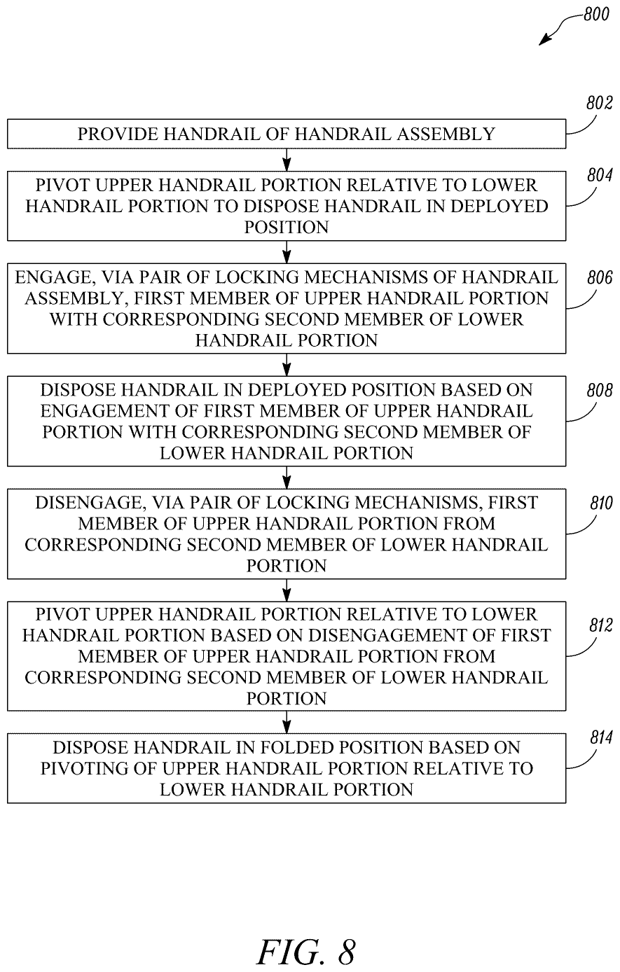

FIG. 8 is a flowchart for a method 800 of operating the handrail assembly 200 of the work machine 100. With reference to FIGS. 1 to 8, at step 802, the handrail 202 of the handrail assembly 200 is provided. The handrail 202 includes the upper handrail portion 204 and the lower handrail portion 206. The upper handrail portion 204 includes the pair of first members 208 spaced apart from each other. The lower handrail portion 208 includes the pair of second members 210 spaced apart from each other. Each second member 210 from the pair of second members 210 defines the opening 212. The handrail 202 is movable between the deployed position and the folded position

At step 804, the upper handrail portion 204 pivots relative to the lower handrail portion 206 to dispose the handrail 202 in the deployed position.

At step 806, the first member 208 of the upper handrail portion 204 is engaged with the corresponding second member 210 of the lower handrail portion 206 via the pair of locking mechanisms 214 of the handrail assembly 200. Each locking mechanism 214 from the pair of locking mechanisms 214 is removably coupled to the corresponding upper handrail portion 204 and the corresponding lower handrail portion 206.

Each locking mechanism 214 from the pair of locking mechanisms 214 includes the insert 216 fixedly coupled with the corresponding first member 208. The step 806 further includes receiving the insert 216 within the opening 212 of the corresponding second member 210 of the lower handrail portion 206 to engage the first member 208 of the upper handrail portion 204 with the second member 210 of the lower handrail portion 206.

Each locking mechanism 214 from the pair of locking mechanisms 214 includes the first tube 218 fixedly coupled with the corresponding first member 208 of the upper handrail portion 204. Each locking mechanism 214 from the pair of locking mechanisms 214 includes the second tube 220 fixedly coupled with the corresponding second member 210 of the lower handrail portion 206. Each locking mechanism 214 from the pair of locking mechanisms 214 includes the pair of first brackets 222. Each first bracket 222 is fixedly coupled with the corresponding first tube 218. Each first bracket 222 includes the first plate 224, the second plate 226, and the intermediate plate 228 that connects the first plate 224 and the second plate 226. The first plate 224 defines the first slot 230 and the second plate 226 defines the second slot 232. Each locking mechanism 214 from the pair of locking mechanisms 214 includes the second bracket 234 fixedly coupled with the corresponding second tube 220. Each second bracket 234 defines the through-opening 236. When the handrail 202 is in the deployed position, the through-opening 236 in the corresponding second bracket 234 aligns with each of the first and second slots 230, 232 in the corresponding first bracket 222. Each locking mechanism 214 from the pair of locking mechanisms 214 includes the fastener 238. The step 806 further includes causing the fastener 238 to slide within the corresponding first slot 230 and the corresponding second slot 232 to dispose the insert 216 within the opening 212 of the corresponding second member 210 of the lower handrail portion 206.

At step 808, the handrail 202 is disposed in the deployed position based on the engagement of the first member 208 of the upper handrail portion 204 with the corresponding second member 210 of the lower handrail portion 206.

At step 810, the first member 208 of the upper handrail portion 204 is disengaged from the corresponding second member 210 of the lower handrail portion 206 via the pair of locking mechanisms 214. The step 810 further includes lifting the upper handrail portion 204 to disengage the insert 216 from the opening 212 of the corresponding second member 210 of the lower handrail portion 206. The step 810 further includes causing the fastener 238 to slide within the corresponding first slot 230 and the corresponding second slot 232 to disengage the insert 216 from the opening 212 of the corresponding second member 210 of the lower handrail portion 206.

At step 812, the upper handrail portion 204 pivots relative to the lower handrail portion 206 based on the disengagement of the first member 208 of the upper handrail portion 204 from the corresponding second member 210 of the lower handrail portion 206.

At step 814, the handrail 202 is disposed in the folded position based on the pivoting of the upper handrail portion 204 relative to the lower handrail portion 206.

It should be noted that the steps 802, 804, 806, 808, 810, 812, 814 of the method 800 may be performed in a sequence that is different from that explained in relation to FIG. 8. Further, various steps 802, 804, 806, 808, 810, 812, 814 can be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A handrail assembly for a work machine, the handrail assembly comprising:
a handrail adapted to be coupled to a frame of the work machine, the handrail including an upper handrail portion and a lower handrail portion, wherein the upper handrail portion includes a pair of first members spaced apart from each other, wherein the lower handrail portion includes a pair of second members spaced apart from each other, wherein each second member from the pair of second members defines an opening, wherein the handrail is movable between a deployed position and a folded position, and wherein, the upper handrail portion is pivotable relative to the lower handrail portion to move the handrail between the deployed position and the folded position; and
a pair of locking mechanisms that removably couple the upper handrail portion with the lower handrail portion, wherein, to dispose the handrail in the deployed position, each locking mechanism from the pair of locking mechanisms engages the first member of the upper handrail portion with a corresponding second member of the lower handrail portion, and wherein, to dispose the handrail in the folded position, each locking mechanism from the pair of locking mechanisms disengages the first member of the upper handrail portion from the corresponding second member of the lower handrail portion.

2. The handrail assembly of claim 1, wherein each locking mechanism from the pair of locking mechanisms includes an insert fixedly coupled with a corresponding first member, and wherein, when the handrail is in the deployed position, the insert is received within the opening of a corresponding second member of the lower handrail portion to engage the first member of the upper handrail portion with the second member of the lower handrail portion.

3. The handrail assembly of claim 2, wherein, to move the handrail from the deployed position to the folded position, the upper handrail portion is lifted to disengage the insert from the opening of the corresponding second member of the lower handrail portion.

4. The handrail assembly of claim 1, wherein each locking mechanism from the pair of locking mechanisms includes a first tube fixedly coupled with a corresponding first member of the upper handrail portion.

5. The handrail assembly of claim 4, wherein each locking mechanism from the pair of locking mechanisms includes a second tube fixedly coupled with a corresponding second member of the lower handrail portion.

6. The handrail assembly of claim 5, wherein each locking mechanism from the pair of locking mechanisms includes a pair of first brackets, wherein each first bracket is fixedly coupled with a corresponding first tube, wherein each first bracket from the pair of first brackets includes a first plate, a second plate, and an intermediate plate that connects the first plate and the second plate, wherein the first plate defines a first slot, and wherein the second plate defines a second slot.

7. The handrail assembly of claim 6, wherein each locking mechanism from the pair of locking mechanisms includes a second bracket fixedly coupled with a corresponding second tube, wherein each second bracket defines a through-opening, and wherein, when the handrail is in the deployed position, the through-opening in a corresponding second bracket aligns with each of the first and second slots in a corresponding first bracket.

8. The handrail assembly of claim 7, wherein each locking mechanism from the pair of locking mechanisms includes a fastener, wherein the fastener movably couples the first bracket with the second bracket, wherein the fastener is received within each of a corresponding first slot in the first plate, a corresponding second slot in the second plate, and a corresponding through-opening in the second bracket, and wherein the fastener is slidable within the corresponding first slot and the corresponding second slot during a movement of the handrail between the deployed position and the folded position.

9. A work machine comprising:
a frame; and
a handrail assembly removably coupled with the frame, the handrail assembly including:
a handrail including an upper handrail portion and a lower handrail portion, wherein the upper handrail portion includes a pair of first members spaced apart from each other, wherein the lower handrail portion includes a pair of second members spaced apart from each other, wherein each second member from the pair of second members defines an opening, wherein the handrail is movable between a deployed position and a folded position, and wherein, the upper handrail portion is pivotable relative to the lower handrail portion to move the handrail between the deployed position and the folded position; and
a pair of locking mechanisms that removably couple the upper handrail portion with the lower handrail portion, wherein, to dispose the handrail in the deployed position, each locking mechanism from the pair of locking mechanisms engages the first member of the upper handrail portion with a corresponding second member of the lower handrail portion, and wherein, to dispose the handrail in the folded position, each locking mechanism from the pair of locking mechanisms disengages the first member of the upper handrail portion from the corresponding second member of the lower handrail portion.

10. The work machine of claim 9, wherein each locking mechanism from the pair of locking mechanisms includes an insert fixedly coupled with a corresponding first member, and wherein, when the handrail is in the deployed position, the insert is received within the opening of a corresponding second member of the lower handrail portion to engage the first member of the upper handrail portion with the second member of the lower handrail portion.

11. The work machine of claim 10, wherein, to move the handrail from the deployed position to the folded position, the upper handrail portion is lifted to disengage the insert from the opening of the corresponding second member of the lower handrail portion.

12. The work machine of claim 9, wherein each locking mechanism from the pair of locking mechanisms includes a first tube fixedly coupled with a corresponding first member of the upper handrail portion, and wherein each locking mechanism from the pair of locking mechanisms includes a second tube fixedly coupled with a corresponding second member of the lower handrail portion.

13. The work machine of claim 12, wherein each locking mechanism from the pair of locking mechanisms includes a pair of first brackets, wherein each first bracket is fixedly coupled with a corresponding first tube, wherein each first bracket includes a first plate, a second plate, and an intermediate plate that connects the first plate and the second plate, wherein the first plate defines a first slot, and wherein the second plate defines a second slot.

14. The work machine of claim 13, wherein each locking mechanism from the pair of locking mechanisms includes a second bracket fixedly coupled with a corresponding second tube, wherein each second bracket defines a through-opening, and wherein, when the handrail is in the deployed position, the through-opening in a corresponding second bracket aligns with each of the first and second slots in a corresponding first bracket.

15. The work machine of claim 14, wherein each locking mechanism from the pair of locking mechanisms includes a fastener, wherein the fastener movably couples the first bracket with the second bracket, wherein the fastener is received within each of a corresponding first slot in the first plate, a corresponding second slot in the second plate, and a corresponding through-opening in the second bracket, and wherein the fastener is slidable within the corresponding first slot and the corresponding second slot during a movement of the handrail between the deployed position and the folded position.

16. A method of operating a handrail assembly of a work machine, the method comprising:
providing a handrail of the handrail assembly, wherein the handrail includes an upper handrail portion and a lower handrail portion, wherein the upper handrail portion includes a pair of first members spaced apart from each other, wherein the lower handrail portion includes a pair of second members spaced apart from each other, wherein each second member from the pair of second members defines an opening, and wherein the handrail is movable between a deployed position and a folded position;
pivoting the upper handrail portion relative to the lower handrail portion to dispose the handrail in the deployed position;
engaging, via a pair of locking mechanisms of the handrail assembly, the first member of the upper handrail portion with a corresponding second member of the lower handrail portion, wherein each locking mechanism from the pair of locking mechanisms is removably coupled to a corresponding upper handrail portion and a corresponding lower handrail portion;
disposing the handrail in the deployed position based on the engagement of the first member of the upper handrail portion with the corresponding second member of the lower handrail portion;
disengaging, via the pair of locking mechanisms, the first member of the upper handrail portion from the corresponding second member of the lower handrail portion;
pivoting the upper handrail portion relative to the lower handrail portion based on the disengagement of the first member of the upper handrail portion from the corresponding second member of the lower handrail portion; and
disposing the handrail in the folded position based on the pivoting of the upper handrail portion relative to the lower handrail portion.

17. The method of claim 16, wherein each locking mechanism from the pair of locking mechanisms includes an insert fixedly coupled with a corresponding first member, and wherein the step of engaging, via the pair of locking mechanisms, the first member of the upper handrail portion with the corresponding second member of the lower handrail portion further includes:
receiving the insert within the opening of a corresponding second member of the lower handrail portion to engage the first member of the upper handrail portion with the second member of the lower handrail portion.

18. The method of claim 17, wherein the step of disengaging, via the pair of locking mechanisms, the first member of the upper handrail portion from the corresponding second member of the lower handrail portion further includes:
lifting the upper handrail portion to disengage the insert from the opening of the corresponding second member of the lower handrail portion.

19. The method of claim 17, wherein each locking mechanism from the pair of locking mechanisms includes a first tube fixedly coupled with a corresponding first member of the upper handrail portion, wherein each locking mechanism from the pair of locking mechanisms includes a second tube fixedly coupled with a corresponding second member of the lower handrail portion, wherein each locking mechanism from the pair of locking mechanisms includes a pair of first brackets, wherein each first bracket is fixedly coupled with a corresponding first tube, wherein each first bracket includes a first plate, a second plate, and an intermediate plate that connects the first plate and the second plate, wherein the first plate defines a first slot and the second plate defines a second slot, wherein each locking mechanism from the pair of locking mechanisms includes a second bracket fixedly coupled with a corresponding second tube, wherein each second bracket defines a through-opening, wherein, when the handrail is in the deployed position, the through-opening in a corresponding second bracket aligns with each of the first and second slots in a corresponding first bracket, wherein each locking mechanism from the pair of locking mechanisms includes a fastener, and wherein the step of engaging, via the pair of locking mechanisms, the first member of the upper handrail portion with the corresponding second member of the lower handrail portion further includes:
causing the fastener to slide within the corresponding first slot and the corresponding second slot to dispose the insert within the opening of the corresponding second member of the lower handrail portion.

20. The method of claim 19, wherein the step of disengaging, via the pair of locking mechanisms, the first member of the upper handrail portion from the corresponding second member of the lower handrail portion further includes:
causing the fastener to slide within the corresponding first slot and the corresponding second slot to disengage the insert from the opening of the corresponding second member of the lower handrail portion.
